(19) United States
(12) Patent Application Publication
(10) Pub. No.: US 2026/0097535 A1
(43) Pub. Date: Apr. 9, 2026

(54) Machine for the Production of Protruded Material from a Flat Substrate and Method of Making the Same

(71) Applicant: Little Feet Packaging, Inc., Wilmington, DE (US)

(72) Inventors: Nicholas P De Luca, Carmel, CA (US); Andrew B. PERKINS, Berkeley, CA (US)

(73) Assignee: Little Feet Packaging, Inc., Wilmington, DE (US)

(21) Appl. No.: 19/352,606

(22) Filed: Oct. 8, 2025

Related U.S. Application Data
(60) Provisional application No. 63/704,730, filed on Oct. 8, 2024.

(51) Int. Cl. B26D 1/22

(52) U.S. Cl. CPC B26D 1/225

(57) ABSTRACT

A machine and method of forming a protruded material from a generally flat substrate is disclosed. The method includes inserting one or more pieces of flat material into a machine; cutting the flat material using a cutting die comprising one or more cutting blades; and pressing together cut pieces of the flat material using a press die to form protrusions, wherein the one or more cutting blades are disengaged from the flat material periodically and the cutting die is repositioned to a starting position that maintains a set distance from the press die.

### CROSS REFERENCE TO RELATED APPLICATIONS

The present application claims the benefit of U.S. Provisional Patent Application No. 63/704,730, filed Oct. 8, 2024, which is incorporated herein in its entirety by reference.

### BACKGROUND

The packaging industry has been transitioning from the use of plastic materials to products made from paper to provide shock and thermal protection for packaging items. The primary types of paper products used include shredded paper, cut or slit paper, indented paper, crumpled paper, layered thin paper, molded pulp and, lastly, engineered paper structures made from Multiple Cut and Adhered Sheets (MCAS) products as further described in U.S. Pat. No. 9,315,312B2.

One of the highest cost factors in the package cushioning industry is the high shipping costs due to the bulky nature of these products. For this reason, manufacturing companies servicing a nationwide market and making these types of bulky packaging products have multiple facilities typically located a short distance from the end customers. As such, start-up companies developing new paper-based materials to replace and compete with the plastic alternatives (such as foam and bubble cushioning) require enormous amounts of capital to establish the large number of manufacturing facilities required.

As an alternative, an on-site, end-user machine that produces the “bulk” of these cushioning products with processes such as inflating, embossing, crumpling, or folding the raw plastic or paper material have become common. For example, companies such as RanPak based in Concord, Ohio, Sealed Air Corporation based in Charlotte, NC and Pregis based in Chicago, IL sell machines to modify flat paper by crumpling it or form plastic cushions to produce the finished bulky product on site. As an example, U.S. Pat. Nos. 5,454,642, 5,651,237, 6,116,000, and 6,410,119 describe machines used to make inflatable package cushioning on-site with the enormous associated benefits of reducing shipping costs and reducing the associated carbon footprint for transportation.

With regard to on-site manufacturing, machines for the processing of paper products have been primarily focused on creating crumpled products (e.g., machines made by Sealed Air, Pregis, Ranpak) or embossed paper (e.g., machines made by the Suzhou Deed Machinery Co., LT in Jiangsu, China).

While MCAS products can be made to provide greater strength, better aesthetics, and more repeatable physical characteristics compared to the alternatives, the machines required to make the product at scale are too large, difficult to operate, and expensive to be placed at an end-user facility. U.S. Pat. Nos. 9,315,312B2, 10,870,949, 11,414,222, and U.S. application Ser. No. 18/477,131 teach methods of making and using MCAS paper formed into domes or with protrusions. U.S. patent application Ser. No. 18/935,394 describes prior art related to forming paper into protrusions.

The difficulty associated with making an inexpensive machine for forming MCAS type products relates to the use of multiple thin sheets of paper, normally in the range of 0.1 mm-0.2 mm in thickness (i.e., 40 lb-60 lb paper basis weight). The multiple thin sheets of paper need to be precisely cut and matched prior to forming. For cutting systems that are strong enough to be used in an industrial process and can operate at high volumes daily (in contrast to a home use crafting system that uses disposable parts with a very limited use), the cutting systems normally employ a cutting die and an anvil. Rotary die cutters are common and include a cylindrical cutting die and a cylindrical anvil that are both made from steel, machined, hardened, and sharpened. These cylinders are also then placed within a mounting system that securely presses both rolls together as the paper material is fed between these. When working with two sheets of paper that have dissimilar cutting patterns, a minimum of 4 dies is required (2 cutting and 2 anvils) and the tolerance held across the die cylinder must be such to avoid a missed cut. As such, the wider a cutting die that is required, the larger diameter of the cylinder that is required to ensure consistent cuts. The overall result of this is an extremely expensive and large cutting system (about $25,000-$50,000 with each cylinder on the order of 400 mm in diameter) that precludes making an inexpensive, small end-user machine to produce MCAS products.

Another problem with making MCAS products as further described in the aforementioned patents relates to the need to align and match the two or more sheets of paper. As the rollers cut the paper, very small mismatching slowly stacks yielding product that is completely misaligned in the web direction. U.S. patent application 63/220,211 “Continuous Process for Forming Domed Paper and Structures” attempts to solve this problem by adjusting the die spacing but the machine described requires the use of a pre-cut paper substrate. Supplying a cut sheet of paper creates difficulties in handling and processing and further adds costs to the raw material.

### OBJECTS OF THE INVENTION

It is therefore a primary objective of the present teachings to disclose a compact, inexpensive, reliable, and easy to use process and machine to produce MCAS paper products.

It is another objective of the present teachings to disclose a system that cuts and forms the product from a flat thin paper substrate.

It is another objective of the present teachings to disclose a cutting system that does not require the use of expensive rotary cylinders.

It is further an objective of the present teachings to disclose a system where an alignment between the cutting dies and the forming die is free of the issues related to geometric stacking.

It is another object of the present teachings to disclose a system where a geometry of the cutting pattern and press die is easily changed.

It is further an object of the present teachings to disclose a system where a speed of processing is adjustable based on end use.

It is further an object of the present teachings to disclose a machine system light enough to be lifted by one person.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In summary, the invention comprises a novel manufacturing process for the production of domed or protruded paper using an engineered paper structure made from multiple cut and adhered sheets of paper (a MCAS product) that further integrates cutting dies and forming dies into a compact unit. A path distance between the cutting die and forming die can be adjusted to ensure proper registration and the cutting die periodically engages and disengages from the substrate as the anvil surfaces move away from the cutting die.

In an embodiment the cutting die is made from thin metal etched sheets, typically known as flexible dies. The cutting dies may be placed on a magnetic roller anvil. In some embodiments, the cutting dies are placed on either side of a hardened steel plate. The plate may be located between two hardened anvil rollers to create a simultaneous cutting surface between both the top and bottom surfaces of the plate and the anvils. In some embodiments, two sheets of adhesive lined paper are introduced between each side of the plate and one or both anvils are moved to create a press point that ensures the paper is cut.

In an embodiment, one of the anvils (for example, the lower anvil) remains fixed in position and is driven with a motor, while an opposing anvil (for example, the upper anvil) is advanced via the friction of the die cutting surfaces and the anvil. In order to enable the simultaneous high bearing load and support required of both, the top anvil “floats” within supports and is further pressed upon from bearings above the interfering area.

One cycle of the method or machine involves the locked movement between the anvil rollers and the press dies such that when the cutting is occurring the press dies that form the shape into the two papers are separated in order to allow the paper to be indexed. When pressing the forming dies, the anvil opens such that the cutting plate can retract and the cutting registration is reset. In this way, any potential error in registration is “cleared” and the distance between the pressing cuts and the forming die remains constant.

The disclosure also provides support for a method of forming a protruded material from a generally flat substrate, the method comprising: inserting one or more pieces of flat material into a machine, cutting the flat material using a cutting die comprising one or more cutting blades, and pressing together cut pieces of the flat material using a press die to form protrusions, wherein the one or more cutting blades are disengaged from the flat material periodically and the cutting die is repositioned to a starting position that maintains a set distance from the press die.

In a first example of the method, the cutting die cuts two patterns simultaneously.

In a second example of the method, optionally including the first example, the cutting die comprises a cutting die plate having two sides, some of the one or more cutting blades are disposed on one of the two sides, and the method further comprises placing anvil rollers on the two sides of the cutting die plate wherein the flat material is located between the anvil rollers and the two sides of the cutting die plate.

In a third example of the method, optionally including one or both of the first and second examples, the anvil rollers move away from the cutting die plate and allow for a disengagement of the flat material from the cutting die plate.

In a fourth example of the method, optionally including one or more or each of the first through third examples, one or more of the anvil rollers are driven to forward the cut pieces of the flat material to the press die.

In a fifth example of the method, optionally including one or more or each of the first through fourth examples, the cutting die is removable.

In a sixth example of the method, optionally including one or more or each of the first through fifth examples, at least one of the anvil rollers is located between the press die and the cutting die plate.

In a seventh example of the method, optionally including one or more or each of the first through sixth examples, the anvil rollers are held in a correct area for pressing with rings, bearings, or supports, that do not completely encircle the anvil rollers.

In an eighth example of the method, optionally including one or more or each of the first through seventh examples, the method further comprises: repositioning the cutting die while the pressing is occurring.

In a ninth example of the method, optionally including one or more or each of the first through eighth examples, the repositioning is done using a spring.

In a tenth example of the method, optionally including one or more or each of the first through ninth examples, the cutting die and the anvil rollers are made of material having a hardness of at least 40 on Rockwell C scale.

In an eleventh example of the method, optionally including one or more or each of the first through tenth examples, the one or more pieces of flat material are continuous on a roll.

In a twelfth example of the method, optionally including one or more or each of the first through eleventh examples, the press die is heated.

The disclosure also provides support for a machine that forms protruded material from a generally flat substrate, the machine comprising: an area for inserting one or more pieces of flat material, a cutting die comprising one or more cutting blades for cutting the flat material, and a press die for pressing together cut pieces of the flat material to form protrusions, Wherein the cutting die comprises one or more cutting blades that are disengaged from the flat material periodically and the cutting die is repositioned to a starting position that maintains a set distance from the press die.

In a first example of the system, the system further comprises: anvil rollers, wherein the cutting die comprises a cutting die plate having two sides, some of the one or more cutting blades are disposed on one of the two sides, the anvil rollers are disposed on the two sides of the cutting die plate, and the flat material is located between the anvil rollers and the two sides of the cutting die plate.

In a second example of the system, optionally including the first example, the anvil rollers move away from the cutting die plate and allow for a disengagement of the flat material from the cutting die plate.

In a third example of the system, optionally including one or both of the first and second examples, one or more of the anvil rollers are driven to forward the cut pieces of the flat material to the press die.

In a fourth example of the system, optionally including one or more or each of the first through third examples, at least one of the anvil rollers is located between the press die and the cutting die plate.

In a fifth example of the system, optionally including one or more or each of the first through fourth examples, one or more of the anvil rollers are held in a correct area for pressing with rings, bearings, or supports, that do not completely encircle the anvil rollers.

In a sixth example of the system, optionally including one or more or each of the first through fifth examples, the anvil rollers and the cutting die are made of material having a hardness of at least 40 on Rockwell C scale.

Additional features will be set forth in the description that follows, and in part will be apparent from the description, or may be learned by practice of what is described.

### DRAWINGS

In order to describe the manner in which the above-recited and other advantages and features may be obtained; a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 is an isometric drawing of a machine able to form protrusions from cut flat material.

FIG. 2 is an isometric drawing showing the primary components of the machine of FIG. 1.

FIGS. 3A, 3B, 3C, 3D, 3E, and 3F are isometric drawings illustrating the process of forming a substrate with protrusions.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION OF DRAWINGS

Embodiments are discussed in detail below. While specific implementations are discussed, this is done for illustration purposes only. A person skilled in the relevant art will recognize that other components and configurations may be used without parting from the spirit and scope of the subject matter of this disclosure.

The terminology used herein is for describing embodiments only and is not intended to be limiting of the present disclosure. As used herein, the singular forms “a,” “an” and “the” are intended to include the plural forms as well, unless the context clearly indicates otherwise. Furthermore, the use of the terms “a,” “an,” etc. does not denote a limitation of quantity but rather denotes the presence of at least one of the referenced items. The use of the terms “first,” “second,” and the like does not imply any order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

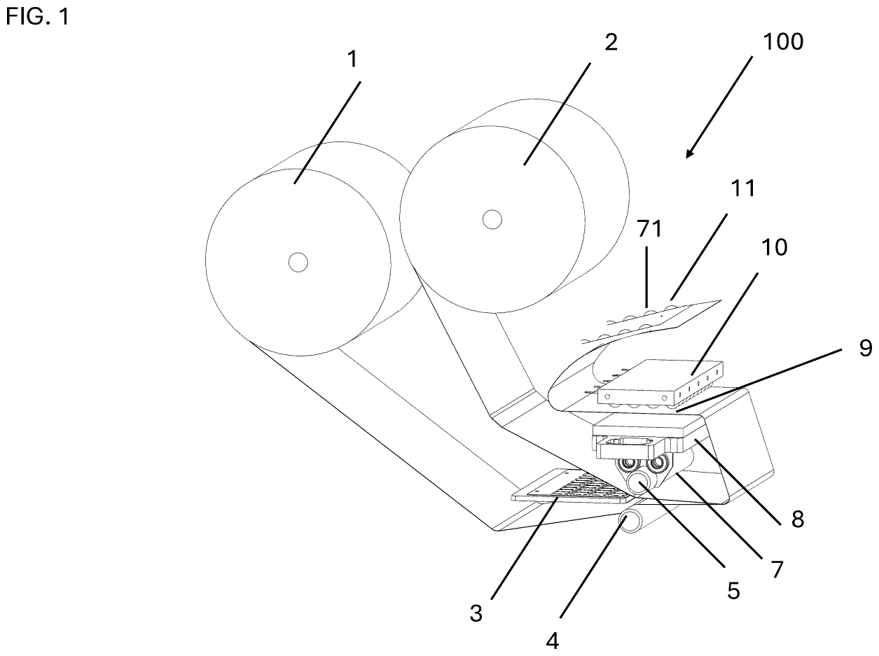

FIG. 1 is an isometric drawing of a machine system 100 for making domed or protruded paper 11 including domes/protrusions 71 with an input of two rolls of heat sealable paper 1 and 2 that are brought together between hardened anvil rollers 4 and 5 with a cutting die plate 3 located between sheets of said heat sealable paper 1 and 2. Protrusions 71 may be formed with a press die plate 10. Heat sealable paper 1 and 2 provides a generally flat substrate or material that is pressed and formed to make protruded paper 11.

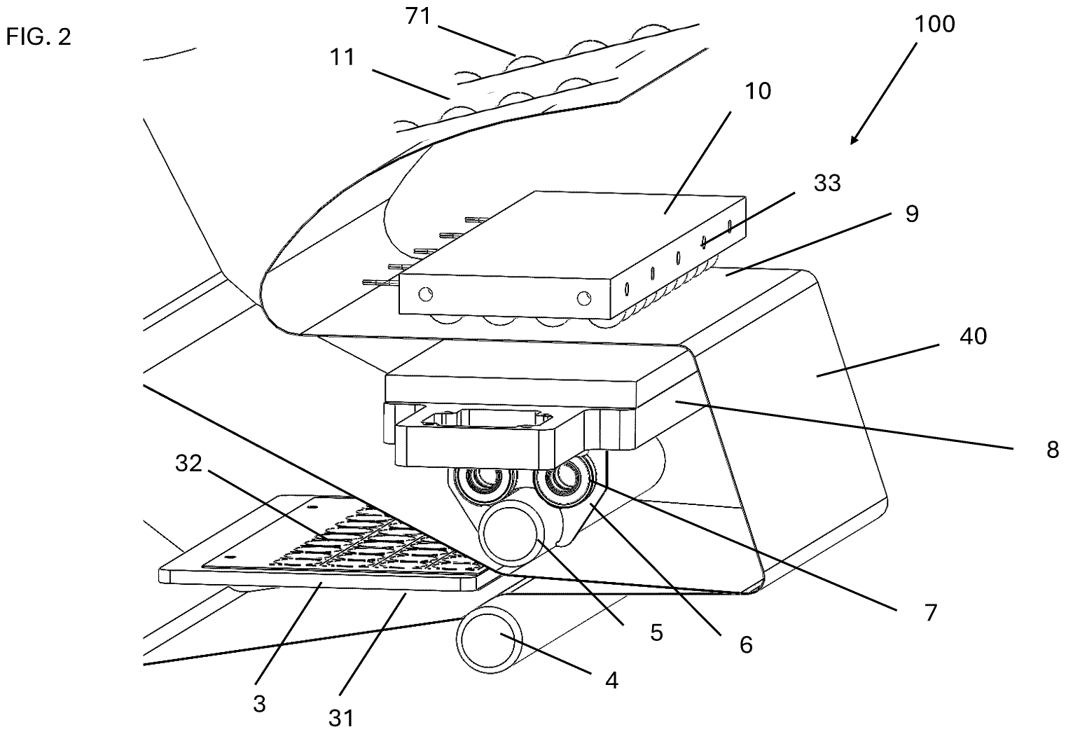

FIG. 2 illustrates that anvil roller 5 acts as a floating anvil that is floated/supported by roller bearings 7 and semi-annular supports 6. In some embodiments, the roller bearings 7 and semi-annular supports 6 do not interfere with the pressing of sheets of heat sealable paper 1 and 2 by anvil roller. In contrast to anvil roller 5, anvil roller 4 is fixed. Cutting die plate 3 moves forward between the anvil roller 4 and 5 along with sheets of said heat sealable paper 1 and 2. Anvil roller 5 is pressed against anvil roller 4 while cutting a section of the sheets. The pressing of anvil roller 5 against anvil roller 4 is performed with a motor (not shown) connected to anvil roller 4 or 5. The section of the sheets to be cut corresponds to the area to be pressed with press die plate 10.

A block or press pad unit 8 having form corresponding to press die plate 10 and protrusions thereupon may be disposed on above anvil roller 5 (the floating anvil). When anvil roller 5 is not pressing down against cutting die plate 3, anvil roller 5 presses up to sandwich the cut pieces of paper 4 and 5 between block 8 and press die plate 10. The sandwiching presses block 8 and the cut pieces into press die plate 10 so as to form protrusions 71 into the protruded paper 11. The cuts sheets are formed between the cutting die plate 3 moving between anvil rollers 4 and 5. Press die plate 10 may be heated with heaters 33 along an area pressing down in area 9 against block 8, when the cutting die plate 3 has completed the cut of a predetermined section and advanced thereto. Paper from heat sealable paper 1 and 2 in area 40 of machine may form a buffer of material to allow for correct registration of cuts that might be formed on both raw materials 1 and 2. Cutting die plate 3 may include cutting surfaces 31 and 32 on both sides of cutting die plate 3 to allow for the cutting of a pattern that uses two layers of material to form a compositive structure that is bonded.

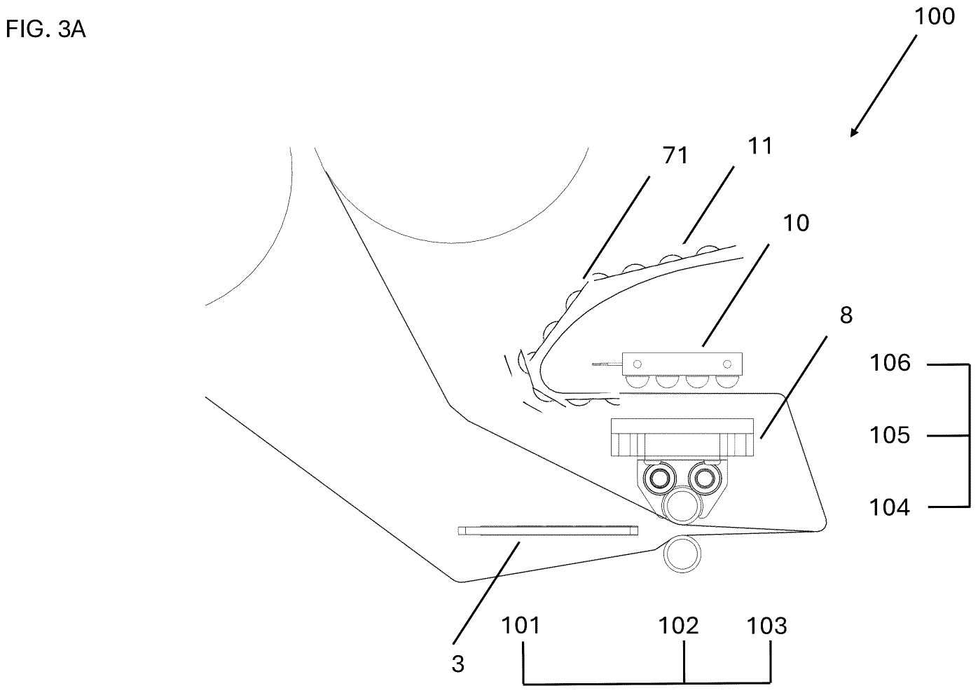

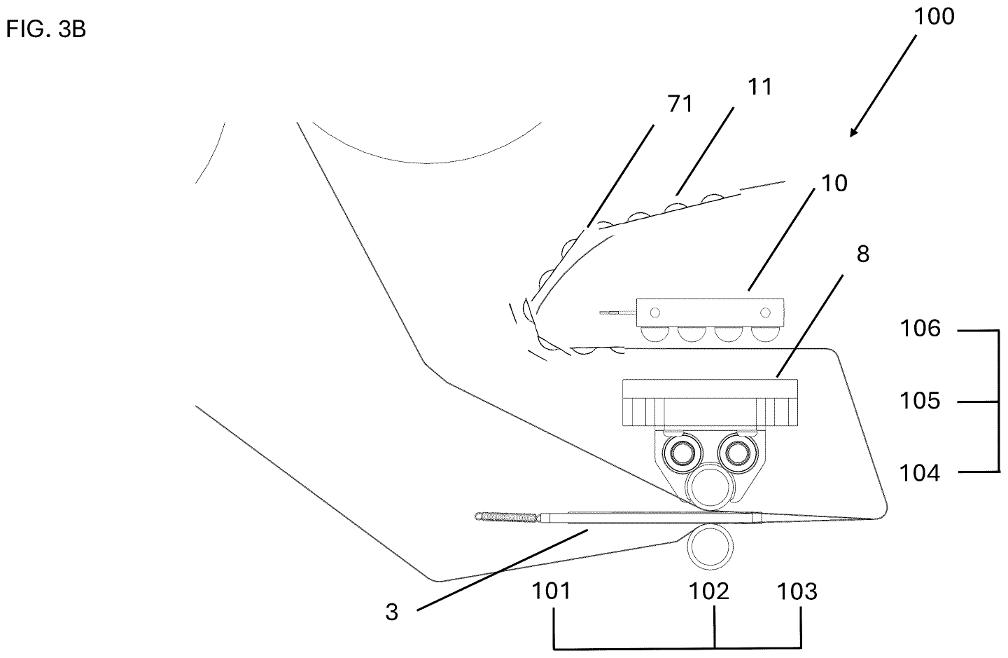

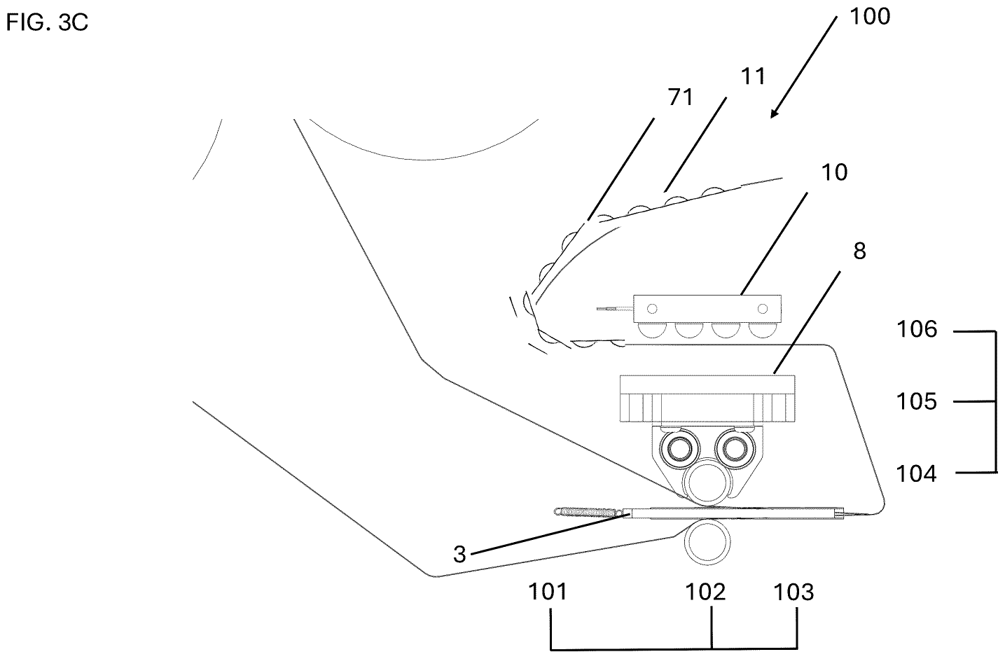

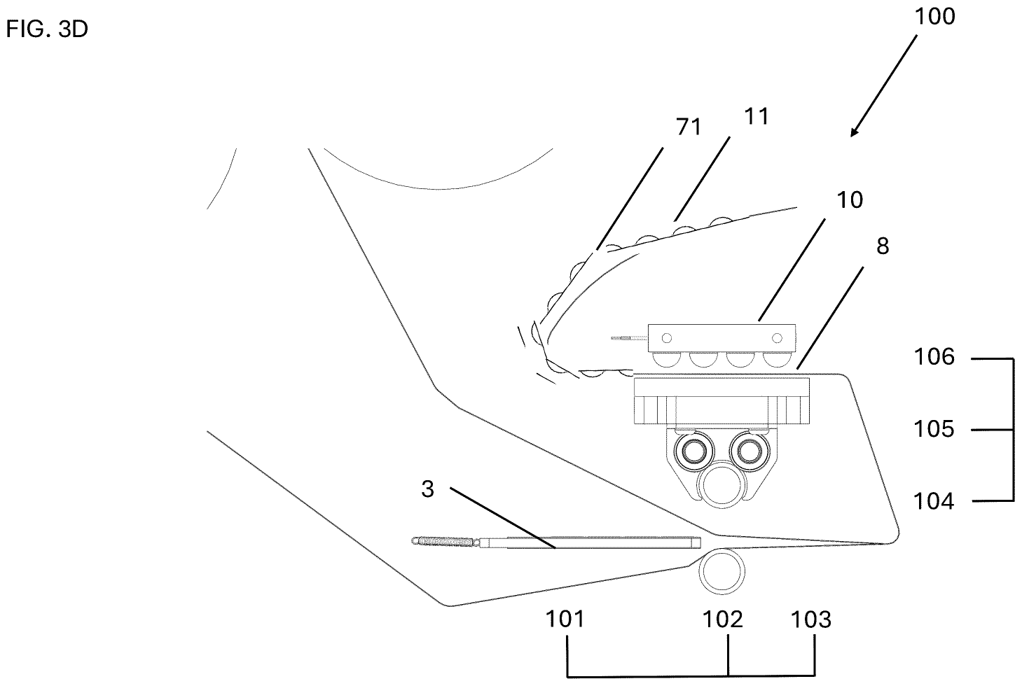

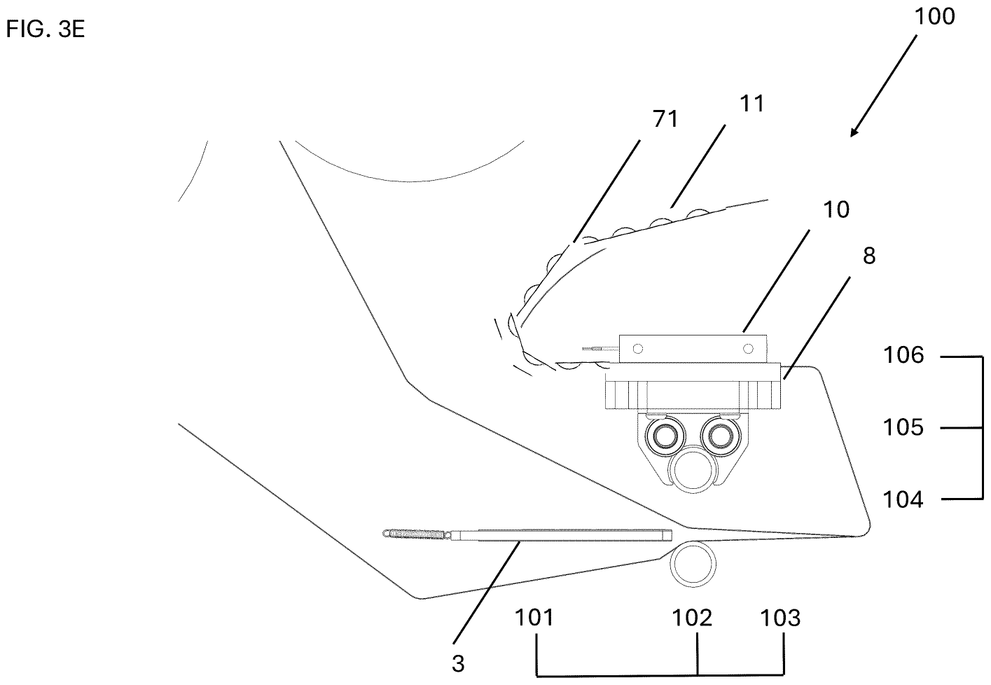

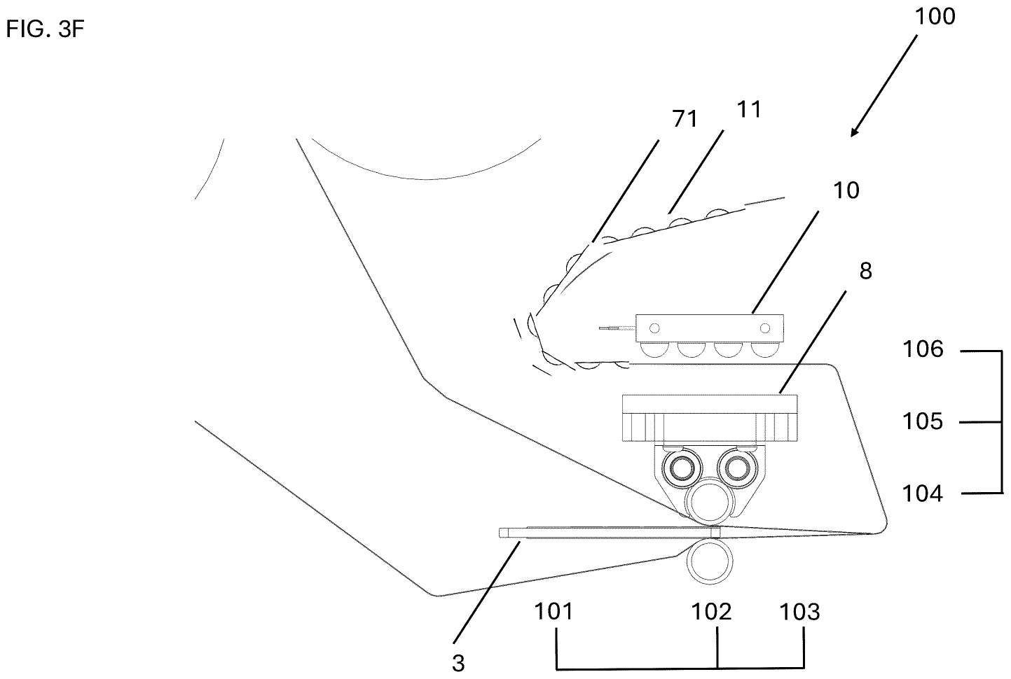

FIGS. 3A, 3B, 3C, 3D, 3E, and 3F are isometric drawings illustrating the process of forming a protruded paper 11 with protrusions 71 from flat material rolls 1 and 2. As shown, materials 1 and 2 are bondable to each other via heat and/or pressure are first cut and then secondarily formed into a material with protrusions by press die plate 10. The cutting process occurs with cutting dies mounted on cutting die plate 3 and located between sheets 1 and 2. The cutting dies press against anvil rollers 4 and 5 and as the plate moves from start position 101 in FIG. 3A, to mid position 102 in FIG. 3B, and end position 103 in FIG. 3C the required pattern to press and form the protrusions is cut. The movement of the plate may be driven separately or simply by rotating one of the anvils via an actuator such as a motor. During this cutting process, the floating anvil and block 8 are located in lower position 104. When cutting die plate 3 arrives at position 103 of FIG. 3C, anvil 5 and block 8 moves to position 105 as shown in FIG. 3D. In FIGS. 3D and 3E, anvil rollers 4 and 5 (also shown in FIGS. 1 and 2) separate from each other, the cutting die plate 3 becomes free to move backwards back to starting position 101. In FIG. 3E, press die plate 10 and the top surface of block 8 that has a soft silicone engage fully to form the protrusions 71 in the cut material such as paper. In some cases protrusions of press die plate 10 and soft silicone on block 8 can be switched. In some cases protrusions of press die plate 10 and soft silicone on block 8 can include cutting knives or perforation knives. After some time, which is generally less than 5 seconds to form the protrusion, block 8 moves back to position 104 releasing the protruded paper 11 such that it can be pulled forward while cutting plate 3 begins to move forward again towards position 103.

The forming and then releasing of the paper is important as it allows for the proper registration and correction through the release of tolerance buildups.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the embodiments described are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

1. A method of forming a protruded material from a generally flat substrate, the method comprising:
inserting one or more pieces of flat material into a machine;
cutting the flat material using a cutting die comprising one or more cutting blades; and
pressing together cut pieces of the flat material using a press die to form protrusions,
wherein the one or more cutting blades are disengaged from the flat material periodically and the cutting die is repositioned to a starting position that maintains a set distance from the press die.

2. The method of claim 1, wherein the cutting die cuts two patterns simultaneously.

3. The method of claim 2, wherein the cutting die comprises a cutting die plate having two sides, some of the one or more cutting blades are disposed on one of the two sides, and the method further comprises placing anvil rollers on the two sides of the cutting die plate wherein the flat material is located between the anvil rollers and the two sides of the cutting die plate.

4. The method of claim 3, wherein the anvil rollers move away from the cutting die plate and allow for a disengagement of the flat material from the cutting die plate.

5. The method of claim 4, wherein one or more of the anvil rollers are driven to forward the cut pieces of the flat material to the press die.

6. The method of claim 5, wherein the cutting die is removable.

7. The method of claim 3, wherein at least one of the anvil rollers is located between the press die and the cutting die plate.

8. The method of claim 3, wherein the anvil rollers are held in a correct area for pressing with rings, bearings, or supports, that do not completely encircle the anvil rollers.

9. The method of claim 1, further comprising repositioning the cutting die while the pressing of the protrusions is occurring.

10. The method of claim 9, wherein the repositioning is done using a spring.

11. The method of claim 3, wherein the cutting die and the anvil rollers are made of material having a hardness of at least 40 on Rockwell C scale.

12. The method of claim 1, wherein the one or more pieces of flat material are continuous on a roll.

13. The method of claim 1, wherein the press die is heated.

14. A machine that forms protruded material from a generally flat substrate, the machine comprising:
an area for inserting one or more pieces of flat material;
a cutting die comprising one or more cutting blades for cutting the flat material; and
a press die for pressing together cut pieces of the flat material to form protrusions,
Wherein the cutting die comprises one or more cutting blades that are disengaged from the flat material periodically and the cutting die is repositioned to a starting position that maintains a set distance from the press die.

15. The machine of claim 14, further comprising anvil rollers, wherein the cutting die comprises a cutting die plate having two sides, some of the one or more cutting blades are disposed on one of the two sides, the anvil rollers are disposed on the two sides of the cutting die plate, and the flat material is located between the anvil rollers and the two sides of the cutting die plate.

16. The machine of claim 15, wherein the anvil rollers move away from the cutting die plate and allow for a disengagement of the flat material from the cutting die plate.

17. The machine of claim 15, wherein one or more of the anvil rollers are driven to forward the cut pieces of the flat material to the press die.

18. The machine of claim 15, wherein at least one of the anvil rollers is located between the press die and the cutting die plate.

19. The machine of claim 15, wherein one or more of the anvil rollers are held in a correct area for pressing with rings, bearings, or supports, that do not completely encircle the anvil rollers.

20. The machine of claim 15, wherein the anvil rollers and the cutting die are made of material having a hardness of at least 40 on Rockwell C scale.
